(19) United States
(12) Patent Application Publication
(10) Pub. No.: US 2025/0390549 A1
(43) Pub. Date: Dec. 25, 2025

(54) SYSTEM AND METHOD FOR TWO-VARIABLE NUMBER THEORETIC TRANSFORMS

(71) Applicant: HUAWEI TECHNOLOGIES CO., LTD., Shenzhen (CN)

(72) Inventors: Yanjun Qian, Waterloo (CA); Wenzhe Yang, Waterloo (CA); Kamalaldin Mozaffari Majd, Waterloo (CA); Mohamed Tolba, Kitchener (CA); Zhiwei Shang, Waterloo (CA); Yunjie Yi, Waterloo (CA)

(21) Appl. No.: 18/750,366

(22) Filed: Jun. 21, 2024

(51) Int. Cl. G06F 17/16; G06F 17/14

(52) U.S. Cl. CPC G06F 17/16; G06F 17/142; G06F 17/144

(57) ABSTRACT

Embodiments of the present application provide a system, a device, and a method for a two-variable number theoretic transform. A matrix having the two-variable number theoretic transform may be applied to a matrix having dimensions a×b, where a=2^{x} and b=2^{y} for x≥y. The two-variable number theoretic transform includes two stages: decomposition by rows and row-wise fast Fourier transforms (FFTs), with twiddle factors computed based on a first root α satisfying α^{b}=−1 mod p; and decomposition by columns and column-wise FFTs, with twiddle factors computed based on a second root β satisfying β^{2a}=2 or −2 mod p. Since each of the stages uses a different root, the number of twiddle factors is reduced.

### FIELD OF INVENTION

The specification relates generally to number theoretic transforms, and more particularly to two-variable number theoretic transforms.

### BACKGROUND

Encryption algorithms are used to encrypt data to be securely transmitted from a source device to a target device. Encryption algorithms may use problems which are computationally hard to solve, such as prime factorization problems and homomorphic ring encryption (i.e., encryption in a homomorphic ring which preserves computations performed on encrypted data) to preclude third parties from intercepting and determining the contents of the secure message. Performing homomorphic operations on encrypted messages may be computationally complex and time consuming.

### SUMMARY

According to an aspect of the present application, a system, device and method for two-variable number theoretic transforms is provided. The system, and particularly a device of the system performs two-variable number theoretic transforms, for example in support of operations (e.g., multiplications) on polynomials in a cryptographic application. The two-variable number theoretic transform may be applied to a matrix having dimensions a×b (i.e., having a rows and b columns), where a=2^{x} and b=2^{y} for x≥y. The two-variable number theoretic transform includes two stages: decomposition by rows and row-wise fast Fourier transforms (FFTs), with twiddle factors computed based on a first root α satisfying α^{b}=−1 mod; and decomposition by columns and column-wise FFTs, with twiddle factors computed based on a second root β satisfying β^{2a}=2 or −2 mod p. Since each of the stages uses a different root from different equations, the number of twiddle factors is reduced. Accordingly, the twiddle factors may be more efficiently generated in real time and/or may occupy less space in memory to pre-store.

According to an aspect of the present application an example method includes: obtaining a time-domain input vector of length N=ab, where a=2^{x} and b=2^{y} for x≥y; converting the input vector to a matrix having dimensions a×b; applying a two-variable number theoretic transform (NTT) to the matrix, wherein the two-variable NTT comprises: decomposing the matrix into a rows and applying a first stage of fast Fourier transforms (FFT) to each row of the matrix, wherein each row has a first vector of b first twiddle factors applied, the respective first twiddle factors computed based on a first root ϕ according to ϕ^{b}=−1 mod p where p is prime; decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and obtaining a frequency-domain resultant vector.

In further examples, the method may additionally include: after the first stage and before the second stage, rescaling the matrix based on the first root and the second root.

In further examples, rescaling the matrix includes: factoring the matrix into two subsets of columns according to the second root β; and applying a respective rescaling vector of a rescaling twiddle factors applied to the columns in each of the two subsets.

In further examples, the method may additionally include: integrating the rescaling into the second stage by combining, for each column in each of the two subsets, the respective second twiddle factor and the respective rescaling twiddle factor.

In further examples, decomposing the matrix into columns includes: transposing the matrix after the first stage; and applying a row-wise decomposition to the transposed matrix.

In further examples, applying the first stage of FFTs includes: applying a nested four-step FFT to each row.

In further examples, applying the second stage FFTs comprises: applying a nested four-step FFT to each column.

In further examples, the method may additionally include: obtaining a second input vector and converting the second input vector to a second matrix; applying the two-variable NTT to the second matrix to obtain a second resultant vector; and multiplying the resultant vector with the second resultant vector element-wise to obtain a frequency-domain product vector.

In further examples, the method may additionally include: applying an inverse two-variable number theoretic transform to the product vector to obtain a time-domain product vector representing a convolution of the input vector and the second input vector.

According to another example, a device includes: a memory; a communications interface; and a processor interconnected with the memory and the communications interface, the processor configured to: obtain a time-domain input vector of length N=ab, where a=2^{x} and b=2^{y} for x≥y; convert the input vector to a matrix having dimensions a×b; apply a two-variable number theoretic transform (NTT) to the matrix, wherein the two-variable NTT comprises: decomposing the matrix into α rows and applying a first stage of fast Fourier transforms (FFT) to each row of the matrix, wherein each row has a first vector of b first twiddle factors applied, the respective first twiddle factors computed based on a first root α according to α^{b}=−1 mod p where p is prime; decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and obtaining a frequency-domain resultant vector.

In further examples, the processor may additionally be configured to: after the first stage and before the second stage, rescale the matrix based on the first root α and the second root β.

In further examples, to rescale the matrix, the processor may be configured to: factor the matrix into two subsets of columns according to the second root β; and apply a respective rescaling vector of a rescaling twiddle factors applied to the columns in each of the two subsets.

In further examples, the processor may additionally be configured to: integrate the rescaling into the second stage by combining, for each column in each of the two subsets, the respective second twiddle factor and the respective rescaling twiddle factor.

In further examples, to decompose the matrix into columns, the processor is configured to: transpose the matrix after the first stage; and apply a row-wise decomposition to the transposed matrix.

In further examples, the processor may additionally be configured to: process each of the first stage FFTs in parallel to obtain element-wise results from each of the FFTs; and store the element-wise results in a transposed configuration to transpose the matrix.

In further examples, to apply the first stage of FFTs, the processor is configured to: applying a nested four-step FFT to each row.

In further examples, to apply the second stage FFTs, the processor is configured to: applying a nested four-step FFT to each column.

In further examples, the processor may additionally be configured to: obtain a second input vector and converting the second input vector to a second matrix; apply the two-variable NTT to the second matrix to obtain a second resultant vector; and multiply the resultant vector with the second resultant vector element-wise to obtain a frequency-domain product vector.

In further examples, the processor may additionally be configured to: apply an inverse two-variable number theoretic transform to the product vector to obtain a time-domain product vector representing a convolution of the input vector and the second input vector.

According to another example, a non-transitory computer-readable medium stores instructions, which when executed by a processor, cause the processor to: obtain a time-domain input vector of length N=ab, where a=2^{x} and b=2^{y} for x>y; convert the input vector to a matrix having dimensions a×b; apply a two-variable number theoretic transform (NTT) to the matrix, wherein the two-variable NTT comprises: decomposing the matrix into a rows and applying a first stage of fast Fourier transforms (FFT) to each row of the matrix, wherein each row has a first vector of b first twiddle factors applied, the respective first twiddle factors computed based on a first root α according to α^{b}=−1 mod p where p is prime; decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and obtaining a frequency-domain resultant vector.

### BRIEF DESCRIPTION OF DRAWINGS

Implementations are described with reference to the following figures, in which:

FIG. 1 depicts a block diagram of an example system for two-variable number theoretic transforms.

FIG. 2 depicts a flowchart of an example method of performing two-variable number theoretic transforms.

FIG. 3 depicts a schematic diagram of applying twiddle factors during a first stage of the two-variable number theoretic transform.

FIG. 4 depicts a schematic diagram of applying twiddle factors during a rescaling operation of the two-variable number theoretic transform.

FIG. 5 depicts a schematic diagram of applying twiddle factors during a second stage of the two-variable number theoretic transform.

FIG. 6 depicts a flowchart of an example method of applying two-variable number theoretic transforms in a cryptographic operation.

### DETAILED DESCRIPTION

Encryption may be based on problems such as, for example, prime factorization. These problems have been determined to be hard problems but may become solvable given a sufficiently powerful quantum computer. Accordingly, new post-quantum encryption schemes remain secure against quantum attacks are sought.

One example of a post-quantum encryption scheme is based on a learning with errors (LWE), which can be extended to ring learning with errors (RLWE) approach. The RLWE approach converts matrix multiplication to polynomial multiplication, thereby enabling number-theoretic transforms (NTTs) to be applied to increase processing speed and reduce processing and computational burden. Multiplication of the polynomials is effectively the convolution between two vectors containing the coefficients of each polynomial, which has a computational complexity of O(n²). To alleviate some of the computational complexity, the vectors may be converted to the frequency domain via a number theoretic transform (NTT) to allow for element-wise multiplication, and subsequently returned to the time domain via an inverse number theoretic transform (INTT).

In particular, the NTT represents a generalization of the fast Fourier transform (FFT) algorithm which allows the computation of the discrete Fourier transform (DFT) of a sequence to convert the signal from its original domain to a representation in the frequency domain, specifically, by using an n-th primitive root of unity. Once in the frequency domain, the signals may be multiplied element-wise before being converted back to the time domain. This reduces the computational complexity to O(n log n), based on the computational complexity of the NTT and INTT algorithms, since element-wise multiplication is simple. For a sufficiently large power-of-two integer N on which the RLWE ring is based, the NTT for the one-variable ring may remain slow.

Accordingly, encryption may be performed based on messages encoded into a two-variable polynomial ring, such as

$$ℛ = ℤ [ X , y ] / 〈 {X}^{\frac{n}{2}} + 1 , {Y}^{\frac{n}{2}} - ( {X}^{\frac{n}{8}} - {X}^{\frac{3 n}{8}} ) 〉 .$$

The encoded messages may then be encrypted to [symbol] _{q}², where [symbol] _{q}= [symbol] /q [symbol] . This polynomial ring provides approximately homomorphic encryption, to allow mathematical operations to be performed on the encrypted data, while maintaining the mathematical result and meaning of the operation in the original polynomial ring after decryption. Further, encryption in a two-variable ring allows for a two-variable number theoretic transform to be performed to multiply encrypted polynomials, to further reduce the computational complexity of the NTT operation, as will be described further herein.

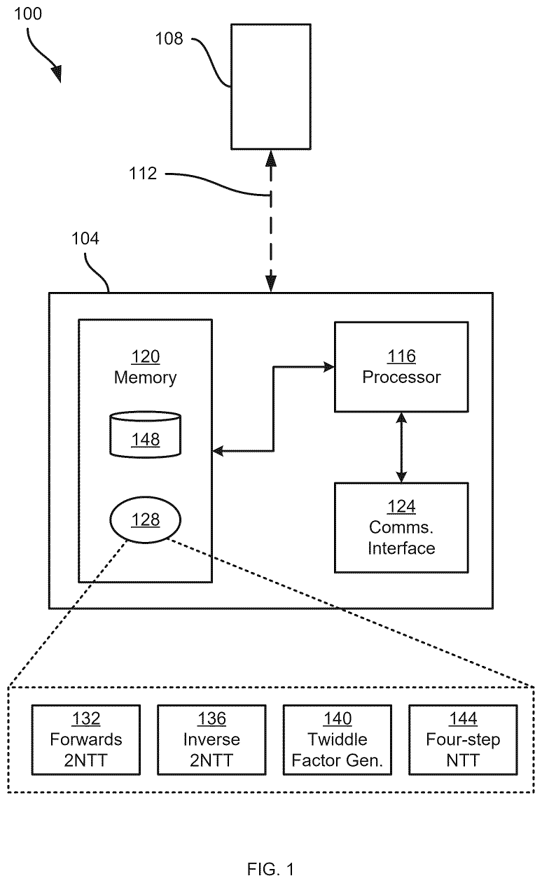

FIG. 1 depicts a system 100 including a device 104 configured for a two-variable number theoretic transform (2NTT). The device 104 may be in communication with a second computing device 108 via one or more communication links 112, including wired and/or wireless communication links, combinations thereof, links which traverse one or more networks, including local area networks, wide-area networks, the internet, and the like.

The devices 104 and 108 may be any suitable computing devices, such as, but not limited to, mobile computing devices such as phones, smart phones, tablets, laptop computers, handheld and/or wearable devices, and the like, or fixed computing devices, such as desktop computers, servers, kiosks, and the like.

The devices 104 and 108 may be in communication to exchange messages, however messages may be vulnerable to attach by a third party to extract information. Accordingly, the devices 104 and 108 may be configured to encrypt messages prior to sending the messages. In particular, the devices 104 and 108 may employ homomorphic or approximately homomorphic encryption, in which an algebraic structure is defined on the ciphertext (i.e., the encrypted messages 116). That is, arithmetic operations may be performed on the ciphertext in the ciphertext space and the encrypted resulting ciphertext may be returned to the source device for decryption. The operation is homomorphic, meaning that a manipulated ciphertext defined by an operation performed on the ciphertext in the ciphertext space may be decrypted, and the resulting decrypted message represents the same operation as performed on the original message. Accordingly, as described herein, the 2NTT system and method provide an efficient method for performing the operations, and in particular multiplications, in the ciphertext space.

The device 104 includes a processor 116, a memory 120 and a communications interface 124.

The processor 116 may include a central processing unit (CPU), a microcontroller, a microprocessor, a processing core, a field-programmable gate array (FPGA), a graphics processing unit (GPU), or similar. The processor 116 may include multiple cooperating processors. The processor 116 may cooperate with the memory 120 to realize the functionality described herein.

The memory 120 may include a combination of volatile (e.g., Random Access Memory or RAM) and non-volatile memory (e.g., read-only memory or ROM, Electrically Erasable Programmable Read Only Memory or EEPROM, flash memory). All or some of the memory 120 may be integrated with the processor 116. The memory stores applications, each including a plurality of computer-readable instructions executable by the processor 116. The execution of the instructions by the processor 116 configures the device 104 to perform the actions discussed herein. In particular, the applications stored in the memory 120 include a 2NTT application 128. When executed by the processor 116, the application 128 configures the processor 116 and/or the device 104 to perform various functions discussed below in greater detail and related to the encryption operation of the device 104. The application 128 may also be implemented as a suite of distinct applications.

For example, in the present example, the application 128 may be implemented in a series of modules including a forwards 2NTT module 132, a 2-variable inverse NTT (2INTT) module 136, a twiddle factor generator 140, and a four-step NTT module 144. For example, the forwards 2NTT module 132 may be configured to apply the 2NTT to a time-domain input vector to obtain a frequency-domain resultant vector. The frequency-domain resultant vector may be multiplied element-wise by other frequency-domain vectors to greatly reduce the computational load of performing traditional polynomial multiplications. In some examples, the four-step NTT module 144 may be configured to apply a more traditional four-step fast Fourier transform (FFT) decomposition nested in 2NTT operation, as will be further described herein, to further accelerate the 2NTT operation. Subsequently, a frequency-domain product vector may be converted back to a time-domain vector by the 2INTT module 136. The twiddle factor generator 140 may be configured to generate the twiddle factors for each of the 2NTT, the four-step NTT and the 2INTT operations.

Further, some or all of the functionality of the application 128 may be implemented as dedicated hardware components, such as one or more FPGAs or application-specific integrated circuits (ASICs). For example, each of the modules may be implemented as an independent ASIC.

The memory 120 also stores a repository 148 storing rules and data for the 2NTT operation. For example, the repository 148 may store the twiddle factors generated by the twiddle factor generator 140 for subsequent 2NTT operations, input and/or resultant vectors, for example for performing multiplications and/or convolutions for cryptographic operations or the like.

The device 104 further includes the communications interface 124 interconnected with the processor 116. The communications interface 124 may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the device 104 to communicate with other computing devices. The specific components of the communications interface 124 are selected based on the types of communication links that the device 104 communicates over, for example to communicate with the device 108.

The device 104 may further include one or more input and/or output devices (not shown). The input devices may include one or more buttons, keypads, touch-sensitive display screen, mice, or the like for receiving input from an operator. The output devices may include one or more display screens, monitors, speakers, sound generators, vibrators, or the like for providing output or feedback to an operator.

The system 100, and in particular, the device 104 is generally configured to perform number theoretic transforms, and more specifically, 2-variable or 2-parameter number theoretic transforms, for example to be applied to multiply polynomials, such as in lattice-based cryptographic applications or the like.

For example, in a ring learning with errors (RLWE)-based post-quantum encryption scheme, the RLWE approach converts matrix multiplication to polynomial multiplication, thereby enabling number theoretic transforms (NTTs) to be applied to increase processing speed and reduce processing and computational burden. For sufficiently large power-of-two integers N on which the RLWE ring is based, the NTT may remain slow, and hence the computational speed of the NTT may remain a bottleneck in computing speed.

Further, a negacyclic version of the NTT includes finding a primitive root α satisfying α^{N}=−1 mod p, where N is the count of the coefficients in the polynomial and p is the prime base for the coefficients of the polynomial. However, such a root does not always exist. The maximum power N determines the maximum order to which the NTT can fully decompose. Typically, the higher N is, the larger the prime will be for the root to be found, and accordingly, to perform a complete transform on a long polynomial, the encoded coefficients are computed on a ring with a larger prime number base. The computational load on the computer may therefore be further increased due to the large numbers involved in the operations.

To accelerate the NTTs, a four-step decomposition may be applied to use butterfly operations to recursively reduce the operations to several two-input-two-output operations. That is, the butterfly operations may represent portions of the computation which combine results of smaller DFTs into a larger DFT. For example, in a radix two operation, each of the two inputs (e.g., x₀ and x₁) is combined to each of two outputs (e.g., y₀=x₀+x₁ and y₁=x₀−x₁). When the flow of data (i.e., the contribution of the inputs x₀ and x₁ to the outputs y₀ and y₁) is mapped, the resulting diagram expresses a butterfly pattern. A twiddle factor may be applied to each butterfly operation as a multiplicative constant which allows the inputs in the butterfly operation to be combined. The twiddle factors may be computed based on the root α as defined above for the NTT, for example according to

$$TF = {e}^{\frac{i 2 π k}{N}}$$

for k=0, 1, . . . , N. However, in order to apply the accelerated NTTs, a large number of twiddle factors may be pre-computed and stored, or computed on the fly, according to the root used for the NTT. Further, additional decompositions further increase the number of twiddle factors computed and stored. Thus, the decomposition of large polynomial NTT operations is hard to implement and may face severe performance degradation due to the expanded number of constants and/or induced data movement and/or other computational issues.

Accordingly, in accordance with the present disclosure, the device 104 may be configured to apply a two-variable or two-parameter NTT (i.e., the 2NTT) using two roots instead of one. For example, the 2NTT may be applied to messages encoded into a two-variable polynomial ring, such as,

$$ℛ = ℤ [ X , y ] / 〈 {X}^{\frac{n}{2}} + 1 , {Y}^{\frac{n}{2}} - ( {X}^{\frac{n}{8}} - {X}^{\frac{3 n}{8}} ) 〉 ,$$

which is subsequently encrypted to [symbol] _{q}², where [symbol] _{q}= [symbol] /q [symbol] . In particular, such a polynomial ring may provide approximately homomorphic encryption, to allow the encrypted polynomials to be modified (e.g., by multiplication) or the like while maintaining security. Accordingly, such encryption schemes may apply the presently described 2NTT method to efficiently perform convolutions on polynomials. That is, the presently described 2NTT method may be applied on the encrypted messages (i.e., polynomials) to convert the polynomials to the a frequency-domain vector, on which a convolution (e.g., a polynomial multiplication) may be applied to increase the efficiency of the polynomial multiplication in the encrypted ring. The result may be returned to a time-domain via the 2INTT method described herein, and returned to a target device for decryption of the modified message.

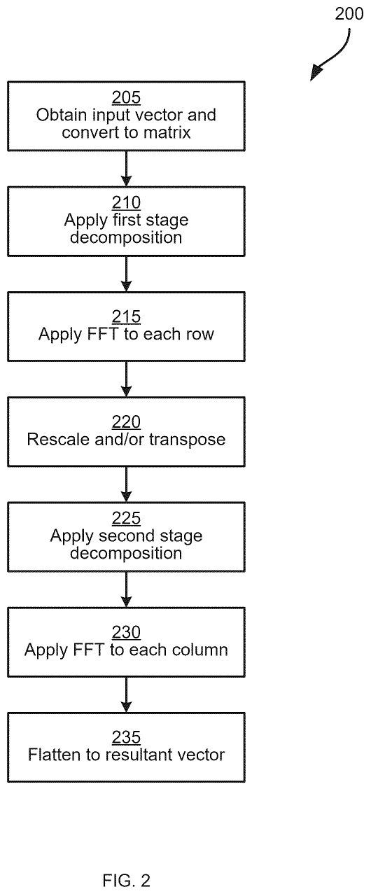

Turning now to FIG. 2, the functionality implemented by the device 104 will be discussed in greater detail. FIG. 2 illustrates a method 200 of performing a 2-variable number theoretic transform. The method 200 will be described in conjunction with its performance in the system 100, and particularly by the device 104, for example via execution of the application 128. In particular, the method 200 will be described with reference to the components of FIG. 1. In other examples, the method 200 may be performed by other suitable devices and/or systems.

At block 205, the device 104 obtains a time-domain input vector having a length N=ab, where a=2^{x} and b=2^{y}, for x≥y. The device 104 may then convert the input vector to a matrix M having dimensions a×b (i.e., having a rows and b columns). That is, the input vector has a size or length that is a power of two, and may further be converted to a matrix representation which also has dimensions which are each powers of two. Since two different roots are used to perform the 2NTT operation, one dimension may be flexible, such that the condition that x=y is dropped.

In some examples, the device 104 may additionally perform other pre-processing transforms to the input vector and/or the matrix representation. For example, the subsequently described operations may cause realignment of the data in the matrix (i.e., movement of elements from one cell in the matrix to a different cell). Accordingly, depending on the downstream operations to be performed on the data, the device 104 may realign the data before or after converting the vector to the matrix representation. Other pre-processing transforms are also contemplated.

At block 210, the device 104, and more particularly, the forwards 2NTT module 132, is configured to apply a first stage decomposition to the matrix obtained at block 205 by decomposing the matrix into rows. That is, the device 104 may define each of the rows as a row vector for subsequent operations. In particular, the device 104 may decompose the matrix M into a rows, each row having a length of b elements.

At block 215, the device 104 is configured to apply a fast Fourier transform to each of the rows obtained at block 210. For example, the device 104 may be configured to perform a decimation-in-time (DIT) FFT to each row.

To perform the FFT, the device 104 may obtain a respective first twiddle factor to be applied during the FFT operation for each element in a row. In particular, each element in a given row may have a different first twiddle factor applied, with each of the rows having the same vector of first twiddle factors (i.e., as applied between rows). In some examples, the twiddle factor generator 140 may be configured to generate and store the twiddle factors (e.g., in the repository 148) in advance of performance of the method 200. In other examples, the forwards 2NTT module 132 may call the twiddle factor generator 140 to generate the twiddle factors in real time. Since the rows obtained at block 210 each have b elements, the twiddle factor generator 140 is configured to compute the twiddle factors based on a first root α satisfying α^{b}=−1 mod p.

In some examples, to further accelerate the FFT operations, the device 104 may nest a four-step FFT at each of the rows. That is, each of the rows may be (1) converted to a matrix; (2) decomposed row-wise to perform further FFTs; (3) apply further twiddle factors; and (4) decompose column-wise to perform further FFTs. Thus, the forwards 2NTT module 132 may call the four-step NTT module 144 to perform the four-step NTTs at each of the rows.

Further, in some examples, the device 104 may be configured to optimize the execution of the FFT operations for improved computational efficiency. For example, the row-wise FFT operations may be run in parallel, for example in different threads within the processor 116 (e.g., within blocks of a GPU or the like). That is, the device 104 may define a given block of the processor 116 to apply the set of FFT operations for the matrix M, as decomposed into a rows. Within each block, the processor 116 may define a threads and assign one thread to process a respective FFT operation for one of the rows. In such examples, the results of each of the FFTs may be output element-wise substantially simultaneously. Accordingly, manipulations may be performed element-wise to the results, for example to transpose the results in preparation for the remainder of the 2NTT operation, as described below. That is, the processor may obtain the element-wise results from each of the FFTs and store the element-wise results in a transposed configuration in order to transpose the matrix. The resulting matrix may therefore be transposed, as compared to its original orientation. The transposition of the result of the first stage decomposition and FFTs may therefore be performed in a local cache, rather than being returned to main memory 120 to be transposed, thereby increasing efficiency and reducing computational burden.

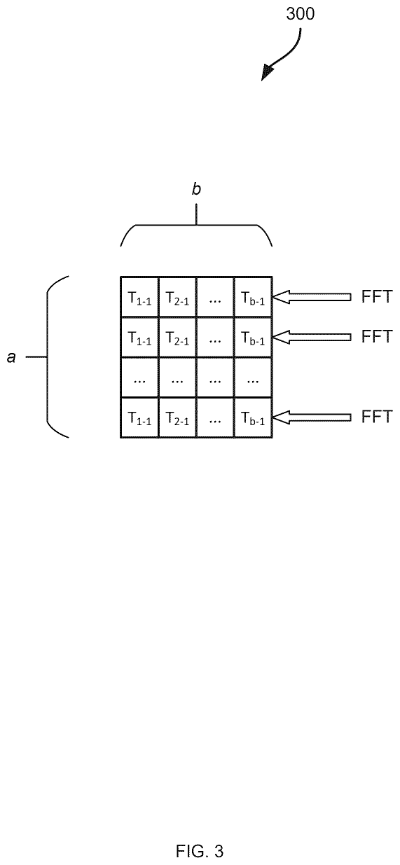

For example, referring to FIG. 3, an example matrix 300 having a rows and b columns is depicted. At block 215, a set of twiddle factors T are generated and applied to the matrix 300. In particular, a first twiddle factor T₁₋₁ is applied to the first of the b elements in each row, a second twiddle factor T₂₋₁ is applied to the second of the b elements in each row, and so forth, until a b^{th} twiddle factor T_{b-1} is applied to the b^{th} elements in each row. In the present example, the subscript “−1” may indicate that the twiddle factor T is applied at the first stage FFT, after the first stage decomposition. A separate FFT may be processed for each of the a rows in the matrix. In particular, each FFT may be processed in parallel operations, such that the results for the corresponding element of in a given column is produced by the FFT substantially simultaneously. This may allow for convenient storage of the resultant matrix in the local cache, for example to achieve a resulting transposition or the like.

Returning to FIG. 2, at block 220, the device 104 may optionally rescale and/or transpose the results of block 215. For example, depending on the scheme selected for the 2NTT operation, and the device 104 may determine further correction coefficients (i.e., further twiddle factors). The twiddle factor generator 140 may generate the twiddle factors for the rescaling based on a second root β satisfying β^{2a}=2 or −2 mod p.

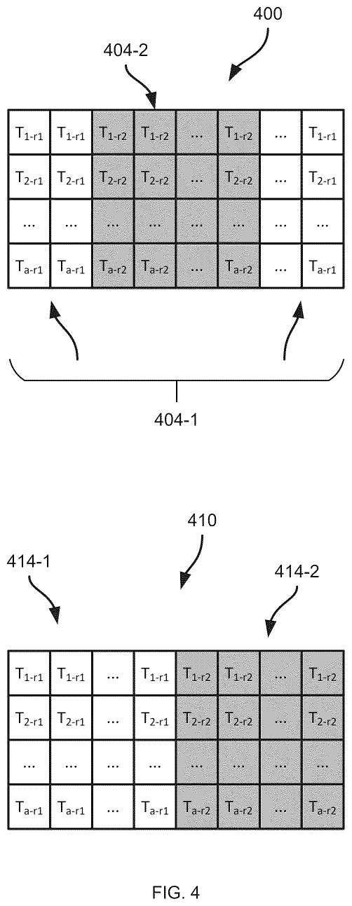

In particular, since the matrix may be decomposed according to the two roots, ¢ and β independently, the b columns of the matrix may additionally be factored into two subsets of columns, according to the second root β. The pattern of the subsets of columns may depend on the selection of the root β, based on whether 2 or −2 is selected. For example, referring to FIG. 4, a schematic diagram of a matrix 400 (e.g., the resultant matrix after performance of block 215 on the matrix 300) is shown with a first pattern of subsets 404-1 and 404-2, shown as unshaded and shaded regions, respectively, according to β²=2 mod p. A matrix 410 is shown with a second pattern of subsets 414-1 and 414-2, shown as shaded and unshaded regions, respectively, according to β^{2a}=−2 mod p.

In particular, based on the root decompositions, the same vector of a twiddle factors (i.e., one twiddle factor for each of the a elements in the column) may be applied to each column within each subset 404-1 and 404-2. That is, a first vector of twiddle factors T₁₋ᵣ₁, . . . , Tₐ₋ᵣ₁ are applied to each of the

$$\frac{b}{2}$$

columns in the subset 404-1, while a second set of twiddle factors T₁₋ᵣ₂, . . . , Tₐ₋ᵣ₂ are applied to each of the

$$\frac{b}{2}$$

columns in the subset 404-2. In the present example, the subscript “-r1” and “-r2” may indicate that the twiddle factor T is applied during rescaling, to the first subset and the second subset of columns, respectively. In particular, the first vector of rescaling twiddle factors T₁₋ᵣ₁, . . . , Tₐ₋ᵣ₁ is based on the root ϕ satisfying ϕ^{a}=−1 mod p, while the second vector of rescaling twiddle factors T₁₋ᵣ₂, . . . , Tₐ₋ᵣ₂ is based on the root β satisfying β^{2a}=2 or −2 mod p.

Similarly, in the example matrix 410, the first vector of rescaling twiddle factors T₁₋ᵣ₁, . . . , Tₐ₋ᵣ₁ are applied to each column in the subset 414-1, and are based on the root ¢ satisfying ϕ^{a}=−1 mod p, while the second vector of rescaling twiddle factors T₁₋ᵣ₂, . . . , Tₐ₋ᵣ₂ are applied to each column in the second subset 414-2, and are based on the root β satisfying β^{2a}=2 or −2 mod p.

Returning again to FIG. 2, in some examples, the device 104 may further apply a transpose to the results of block 215, for example, if the transpose was not integrated into the operation at block 215. In still further examples, rather than applying a transpose, the further operations as described herein may be applied column-wise.

At block 225, the device 104 is configured to apply a second stage decomposition to the matrix obtained at block 205 by decomposing the matrix M into columns, according to the original orientation of the matrix M. That is, the device 104 may define each of the columns as a column vector for subsequent operations. In particular, the device 104 may decompose the matrix M into b columns, each having a length of a elements.

In some examples, the second stage decomposition may be applied column-wise according to the current orientation of the matrix M, for example if the results of the first decomposition are not transposed. In other examples, the column-wise decomposition (as defined by the original orientation of the matrix M) at block 225 may practically implemented in the device 104 as a row-wise decomposition, for example, if the matrix M is transposed after performance of block 215.

As described below, the second stage decomposition will be described as a column-wise decomposition, with respect to the original orientation of the matrix M. In other examples, or in practice (e.g., to optimize hardware performance and/or computer efficiency, etc.), the column-wise decomposition may be implemented via a transposition of the matrix M after performance of block 215 and a row decomposition. In still further examples, the second stage decomposition may be implemented in other manners according to the desired hardware optimizations or implementations of the second stage decomposition, for example.

At block 230, the device 104 is configured to apply a FFT to each of the columns obtained at block 225. For example, the device 104 may be configured to perform a DIT FFT to each column.

To perform the DIT, the device 104 may obtain a respective second twiddle factor to be applied during the DIT operation for each column. In particular, each column may have a different second twiddle factor applied. As with the twiddle factors for the row-wise DIT FFTs, the twiddle factor generator 140 may be configured to generate and store the twiddle factors in advance of the performance of the method 200, or the forwards 2NTT module 132 may call the twiddle factor generator 140 to generate the twiddle factors in real time. Since the columns obtained at block 225 have a elements, the twiddle factor generator 140 is configured to compute the twiddle factors based on a second root β satisfying β^{2a}=2 or −2 mod p.

In particular, since the second twiddle factors are computed with respect to the second root β, each element in a given column may have a different second twiddle factor applied, with each of the columns having the same vector of second twiddle factors (i.e., as applied between columns), rather than requiring that new twiddle factors be computed for each column.

In some examples, to further accelerate the FFT operations, the device 104 may nest a four-step FFT at each of the columns. That is, each of the columns may be (1) converted to a matrix; (2) decomposed row-wise to perform further FFTs; (3) adjusted by applying further twiddle factors; and (4) decomposed column-wise to perform further FFTs. Thus, the forwards 2NTT module 132 may call the four-step NTT module 144 to perform the four-step NTTs at each of the columns.

Additionally, the nested four-step NTTs may have an additional reduction in the number of twiddle factors to be applied. In particular, since each column in a given subset has the same vector of twiddle factors applied to its elements (i.e., rather than different vectors of twiddle factors being computed for each column), a set of twiddle factors for one of the column-wise FFTs may be computed and applied (e.g., with a correction factor if necessary) to each of the other column-wise FFTs. That is, rather than computing separate sets of twiddle factors for each of the nested column-wise FFTs, the same set of twiddle factors may be applied to each of the nested column-wise FFTs.

As with the first stage FFTs, in some examples, the device 104 may be configured to optimize the execution of the FFT operations for improved computational efficiency. For example, each of the column-wise FFT operations may be performed on a separate thread within a block of a GPU to allow for parallel processing, and obtention of the results of each FFT substantially simultaneously. Additionally, the resulting matrix may be transposed as compared to its input orientation. Further, the transposition may be performed in a local cache rather than being returned to main memory 120 to be transposed, thereby increasing efficiency and reducing computational burden.

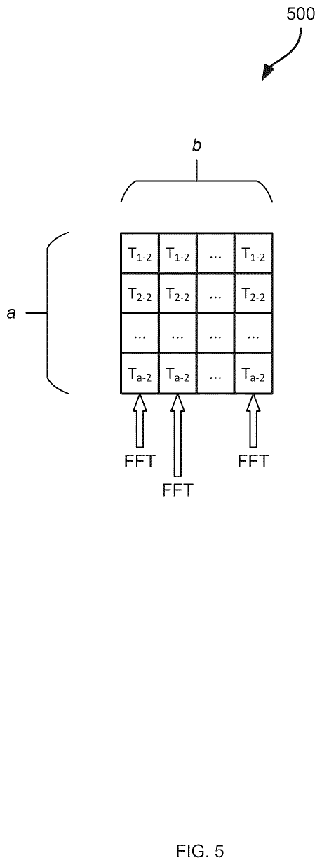

For example, referring to FIG. 5, an example matrix 500 (e.g., the resultant matrix after performance of block 220 on the matrix 400 or the resultant matrix after performance of block 215 on the matrix 300, if block 220 is not performed) is shown with a rows and b columns. At block 230, another set of twiddle factors T are generated and applied to the matrix 500. In particular, a first twiddle factor T₁₋₂ is applied to the first of the a elements in each column, a second twiddle factor T₂₋₂ is applied to the second of the a elements in each column, and so forth, until an a^{th} twiddle factor Tₐ₋₂ is applied to the a^{th} elements in each of the b rows. In the present example, the subscript “−2” may indicate that the twiddle factor T is applied at the second stage FFT, after the second stage decomposition. A separate FFT may be processed for each of the b columns in the matrix. In particular, each FFT may be processed in parallel operations, such that each of the elements in a given one of the a rows is processed substantially simultaneously, and the results for the corresponding elements in the given row is produced by the FFT substantially simultaneously.

In some examples, rather than applying the rescaling separately from the second stage FFTs, the rescaling operation at block 220 may be integrated with the FFTs applied at block 230 via integration into the twiddle factors. That is, the twiddle factors that would be applied during the rescaling operation at block 220 may be multiplied by (or otherwise aggregated to or integrated with) the twiddle factors that would be applied during the second stage FFT operation at block 230. These product twiddle factors may then be used as the twiddle factors to be applied at the second stage FFT operation at block 230. Thus, in such examples, each of the two vectors of twiddle factors may be applied per column within each respective subset, wherein the subsets are defined according to the second root β satisfying β^{2a}=2 or −2 mod p.

Thus, for example, each of the twiddle factors enumerated in FIG. 4 may be combined with the corresponding twiddle factors enumerated in FIG. 5. As will be appreciated, since the twiddle factors are shared column-wise, the combination of twiddle factors results in maintenance of a fewer number of overall twiddle factors. For example, Table 1 depicts the number of twiddle factors using the traditional 4-step NTT in one variable, and the two-variable NTT as presently described:

TABLE 1
Twiddle Factors used in NTT algorithms

| Algorithm | Number of Twiddle Factors |
|---|---|
| One-variable NTT (with rescaling) | b + a + a * b |
| One-variable NTT (rescaling | b + b * a |
| integrated with second stage) | |
| Two-variable NTT (with rescaling) | b + 3a |
| Two-variable NTT (rescaling | b + 2a |
| integrated with second stage) | |

At block 235, after obtaining the results from block 230, the device 104 may be configured to flatten the result matrix to a resultant vector. In particular, the resultant vector may be a frequency-domain vector. As a result, the frequency-domain resultant vector may be processed (e.g., multiplied) element-wise with another frequency-domain vector, for example for cryptographic applications in a homomorphic ring to maintain security of encrypted data. In other examples, when a matrix representation is desired as an output, block 235 may be skipped. In still further examples, the device 104 may perform further post-processing operations, including data realignment operations, or the like, in preparation for further downstream operations.

As described, the method 200 of applying an NTT in 2 variables allows for a reduction in the number of twiddle factors computed and stored, or computed in real time, thereby reducing the computational complexity and/or increasing the computational efficiency of the device 104.

In practice, the 2NTT operation may be applied to simplify polynomial multiplication, for example in cryptographic operations. Thus, for example, a message may be encoded into a polynomial. The polynomial may then be encrypted to a polynomial ring for secure transmission between, for example, the devices 104 and 108. In particular, the polynomial ring may be homomorphic to allow operations to be performed on the encrypted polynomial while maintaining the meaning of the operation on the message after a subsequent decryption.

Performing multiplication operations may be time consuming due to the computational complexity of polynomial multiplication. Accordingly, particularly when the polynomial ring is also a two-variable polynomial ring, cryptographic operations may apply the above-noted two-variable NTT operation to simplify the computational complexity of the polynomial multiplication.

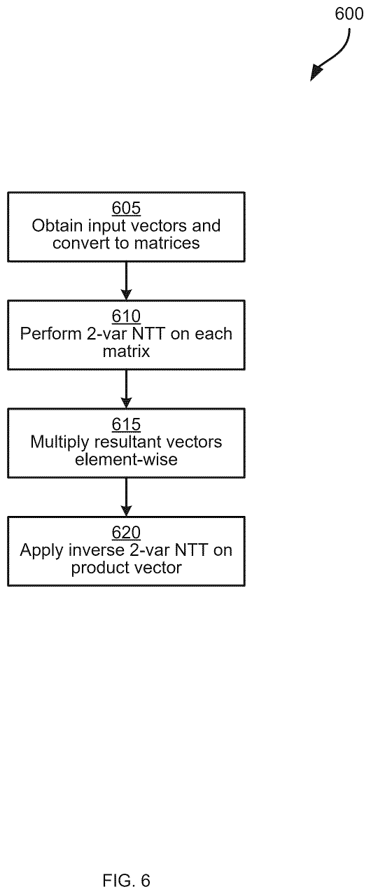

For example, referring to FIG. 6, a flowchart of an example method 600 of vector convolution is depicted. The method 600 will also be described with reference to its performance by the device 104; in other examples, the method 600 may be performed by other suitable devices and/or systems.

At block 605, the device 104 is configured to obtain two input vectors for convolution. The device 10 may convert each of the input vectors to corresponding input matrix representations, and perform data alignment adjustments as appropriate on each of the input vectors and/or input matrix representations.

At block 610, the device 104 is configured to perform a two-variable number theoretic transform on each of the input matrix representations. For example, the device 104 may iterate through the method 200 for each input matrix representation. As a result, the device 104 obtains two frequency-domain resultant vectors (e.g., including in matrix form).

Notably, since the square condition of the matrix representations is dropped, the matrix may be decomposed to the last layer. Accordingly, at block 615, the device 104 may multiply the two frequency-domain resultant vectors element-wise to obtain a product vector.

At block 620, the device 104 may apply the inverse two-variable NTT operation (i.e., by calling the inverse 2NTT module 136) to convert the product vector back to the time domain to obtain the convoluted product of the two input vectors. That is, the convoluted time-domain product may represent a result of an operation on an encrypted ciphertext in the ciphertext domain. Accordingly, the resulting product may be decoded from matrix form back to polynomial form to be transmitted back to a source device (e.g., one of the devices 104 and 108) and subsequently decrypted to determine the result of the operation on the original message.

As described herein, a two-variable number theoretic transform may be applied to a matrix having dimensions a×b (i.e., having a rows and b columns), where a=2^{x} and b=2^{y} for x≥y. The two-variable number theoretic transform includes two stages: decomposition by rows and row-wise fast Fourier transforms (FFTs), with twiddle factors computed based on a first root ϕ satisfying ϕ^{b}=−1 mod p; and decomposition by columns and column-wise FFTs, with twiddle factors computed based on a second root β satisfying β^{2a}=2 or −2 mod p. Since each of the stages uses a different root, the number of twiddle factors is reduced.

In this application, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present application.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). For example, “at least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The scope of the claims should not be limited by the embodiments set forth in the above examples but should be given the broadest interpretation consistent with the description as a whole.

1. A method comprising:
obtaining a time-domain input vector of length N=ab, where a=2^{x} and b=2^{y} for x≥y;
converting the input vector to a matrix having dimensions a×b;
applying a two-variable number theoretic transform (NTT) to the matrix, wherein the two-variable NTT comprises:
decomposing the matrix into a rows and applying a first stage of fast Fourier transforms (FFT) to each row of the matrix, wherein each row has a first vector of b first twiddle factors applied, the respective first twiddle factors computed based on a first root α according to α^{b}=−1 mod p where p is prime;
decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and
obtaining a frequency-domain resultant vector.

2. The method of claim 1, further comprising:
after the first stage and before the second stage, rescaling the matrix based on the first root α and the second root β.

3. The method of claim 2, wherein rescaling the matrix comprises:
factoring the matrix into two subsets of columns according to the second root β; and
applying a respective rescaling vector of a rescaling twiddle factors applied to the columns in each of the two subsets.

4. The method of claim 3, further comprising:
integrating the rescaling into the second stage by combining, for each column in each of the two subsets, the respective second twiddle factor and the respective rescaling twiddle factor.

5. The method of claim 1, wherein decomposing the matrix into columns comprises:
transposing the matrix after the first stage; and
applying a row-wise decomposition to the transposed matrix.

6. The method of claim 1, wherein applying the first stage of FFTs comprises:
applying a nested four-step FFT to each row.

7. The method of claim 1, wherein applying the second stage FFTs comprises:
applying a nested four-step FFT to each column.

8. The method of claim 1, further comprising:
obtaining a second input vector and converting the second input vector to a second matrix;
applying the two-variable NTT to the second matrix to obtain a second resultant vector; and
multiplying the resultant vector with the second resultant vector element-wise to obtain a frequency-domain product vector.

9. The method of claim 8, further comprising:
applying an inverse two-variable number theoretic transform to the product vector to obtain a time-domain product vector representing a convolution of the input vector and the second input vector.

10. A device comprising:
a memory;
a communications interface; and
a processor interconnected with the memory and the communications interface, the processor configured to:
obtain a time-domain input vector of length N=ab, where a=2^{x} and b=2^{y} for x≥y;
convert the input vector to a matrix having dimensions a×b;
apply a two-variable number theoretic transform (NTT) to the matrix, wherein the two-variable NTT comprises:
decomposing the matrix into a rows and applying a first stage of fast Fourier transforms (FFT) to each row of the matrix, wherein each row has a first vector of b first twiddle factors applied, the respective first twiddle factors computed based on a first root α according to α^{b}=−1 mod p where p is prime;
decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and
obtaining a frequency-domain resultant vector.

11. The device of claim 10, wherein the processor is further configured to:
after the first stage and before the second stage, rescale the matrix based on the first root α and the second root β.

12. The device of claim 11, wherein, to rescale the matrix, the processor is configured to:
factor the matrix into two subsets of columns according to the second root β; and
apply a respective rescaling vector of a rescaling twiddle factors applied to the columns in each of the two subsets.

13. The device of claim 12, wherein the processor is further configured to:
integrate the rescaling into the second stage by combining, for each column in each of the two subsets, the respective second twiddle factor and the respective rescaling twiddle factor.

14. The device of claim 10, wherein, to decompose the matrix into columns, the processor is configured to:
transpose the matrix after the first stage; and
apply a row-wise decomposition to the transposed matrix.

15. The device of claim 14, wherein the processor is configured to:
process each of the first stage FFTs in parallel to obtain element-wise results from each of the FFTs; and
store the element-wise results in a transposed configuration to transpose the matrix.

16. The device of claim 10, wherein, to apply the first stage of FFTs, the processor is configured to:
apply a nested four-step FFT to each row.

17. The device of claim 10, wherein, to apply the second stage FFTs, the processor is configured to:
apply a nested four-step FFT to each column.

18. The device of claim 10, wherein the processor is further configured to:
obtain a second input vector and converting the second input vector to a second matrix;
apply the two-variable NTT to the second matrix to obtain a second resultant vector; and
multiply the resultant vector with the second resultant vector element-wise to obtain a frequency-domain product vector.

19. The device of claim 18, wherein the processor is further configured to:
applying an inverse two-variable number theoretic transform to the product vector to obtain a time-domain product vector representing a convolution of the input vector and the second input vector.

20. A non-transitory computer-readable medium storing instructions, which when executed by a processor, cause the processor to:
obtain a time-domain input vector of length N=ab, where a=2^{x} and b=2^{y} for x>y;
convert the input vector to a matrix having dimensions a×b;
apply a two-variable number theoretic transform (NTT) to the matrix, wherein the two-variable NTT comprises:
decomposing the matrix into a rows and applying a first stage of fast Fourier transforms (FFT) to each row of the matrix, wherein each row has a first vector of b first twiddle factors applied, the respective first twiddle factors computed based on a first root α according to α^{b}=−1 mod p where p is prime;
decomposing the matrix into b columns and applying a second stage of FFTs to each column of the matrix, wherein each column has a second vector of a second twiddle factors applied, the respective second twiddle factors computed based on a second root β according to β^{2a}=2 or −2 mod p; and
obtaining a frequency-domain resultant vector.
